(19) United States
(12) Patent Application Publication
(10) Pub. No.: US 2012/0255506 A1
(43) Pub. Date: Oct. 11, 2012

(54) Leash With Fastener in Handle

(76) Inventor: Michael Dean Anthony, (US)

(21) Appl. No.: 13/080,657

(22) Filed: Apr. 6, 2011

(51) Int. Cl. A01K 27/00

(52) U.S. Cl. 119/793

(57) ABSTRACT

What we are changing in a typical dog (or other animal) leash is how it may be secured to a fixed object. We are adding a fastener (i.e. a clip or buckle) to the handle, or looped end, of a leash therefore making it easier to tether an animal to a fixed object. Simply unclip the fastener, loop the handle around a post or pole, and re-clip the fastener. The dog never needs to be unleashed.

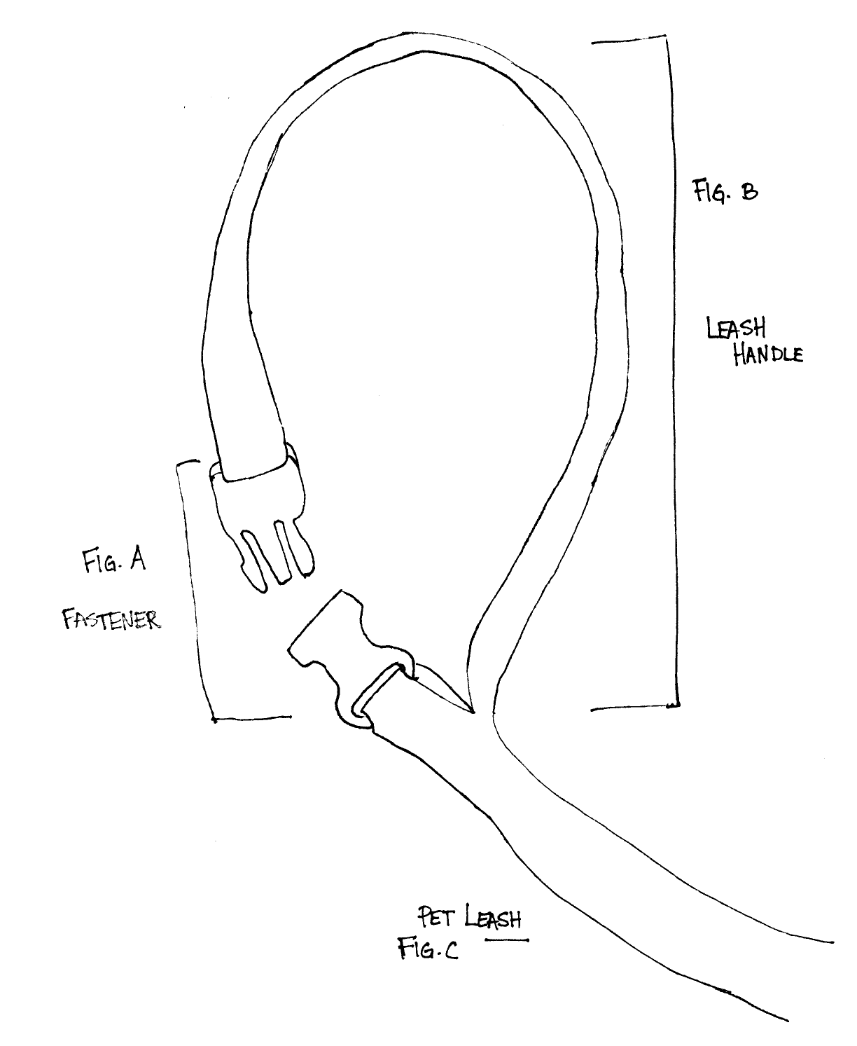

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention pertains to dog (and other animal) leashes.

This invention is different than existing dog leashes in that it has a fastener in the handle of the leash. Where a typical loop is located in the handle of a dog leash, we have added an easily unclasping clip, which does not take away from the comfort of said handle. This invention is an improvement on the existing dog leash because the dog never has to be disconnected from the leash in order to secure the leash to a fixed object.

### BRIEF SUMMARY OF THE INVENTION

A dog (or other animal) leash which contains an easily unclaspable clip in the looped handle of said leash.

Use of said invention is incredibly easy and helpful to all dog owners/care takers. Now a dog can easily be restrained/tied to a fixed object (i.e. tree, pole, table/bench/chair etc. leg, etc.) without having to disconnect the dog leash from the dog collar. Simply by unbuckling the handle, the handle itself can then be secured around said fixed object, all while maintaining control and leashing of the dog. If the handle is not large enough to fit around said fixed object (i.e. a tree) the leash can easily encompass said fixed object and the handle would then be unbuckled and secured around the remainder of the leash, creating a larger loop in which to secure the dog.

### BRIEF DESCRIPTION OF THE DRAWING

FIG. A shows the fastener in the handle of the leash

FIG. B shows the leash handle

FIG. C shows the pet leash

### DETAILED DESCRIPTION OF THE INVENTION

This invention, Leash with Fastener in Handle, is comprised of a dog (or other animal) leash in which the handle has an easily opened clip. This opening allows for easier, safer, tethering of the dog. The owner can now easily secure the dog to a fixed object without ever having to disconnect the leash from the dog collar. Tethering is possible for people of all abilities and strengths, as now the fixed object does not have to be moved or lifted. Currently tethering options include a leash permanently fixed to an immovable object such as a backyard tether; a dog run in which one end of the leash is attached to a cable and the opposite end attached to the dog collar; and disconnecting the leash from the dog collar in order wrap the leash around a fixed object and then to loop the clasping end through the handle to reconnect to the dog collar. All of which offer limited locations and make it quite hard to tether at a moment's notice. This invention allows the dog owner to quickly secure the dog anywhere the owner desires, with ease. Simply unbuckle the clip located in the handle of the leash; wrap the the clasping end through the handle to reconnect to the dog collar. All of which offer limited locations and make it quite hard to tether at a moment's notice. This invention allows the dog owner to quickly secure the dog anywhere the owner desires, with ease. Simply unbuckle the clip located in the handle of the leash; wrap the handle around a fixed object such as a pole, table leg or railing; and re-clasp the clip. The dog is now secured to the fixed object and has never been disconnected from its leash. If the circumference of the handle of the leash is too small to wrap around the fixed object (i.e. a tree), the entire leash—while staying connected to the dog collar—can be wrapped around the tree; the handle unbuckled and secured around the leash, creating a slip knot.

Manufacturing of said leash, and handle, is easily accomplished by simply adding a buckle near the connection of leash handle to the rest of the leash.

1. The invention claimed here is solely of the fastener to be added to the handle of a dog leash; wherein the improvement lies in the fastener, making tethering a dog (or other animal) much easier.
